(19) United States
(12) Patent Application Publication
(10) Pub. No.: US 2026/0127964 A1
(43) Pub. Date: May 7, 2026

(54) Parking Location Navigation System and Method

(71) Applicant: Melissa Henry, Montreal-Ouest (Quebec) (CA)

(72) Inventor: Melissa Henry, Montreal-Ouest (Quebec) (CA)

(21) Appl. No.: 18/938,851

(22) Filed: Nov. 6, 2024

(51) Int. Cl. G08G 1/14; B60W 30/06; G06V 20/13

(52) U.S. Cl. CPC G08G 1/141; B60W 30/06; G06V 20/13; G08G 1/145; B60W 2556/40

(57) ABSTRACT

A community-driven computerized vehicle navigation system and method operates to direct vehicles to available parking spaces. Information on potential parking spaces is stored in a parking map database. Using a real time map server automotive navigation system (ANS) information, parking sign data and earth/street view images are processes, perhaps with an AI module, to generate individual parking space data that is stored in parking map database. Information from the map database is sent to a real time map server, which transmits it to a personal navigation device that is in the vehicle, which displays streets in the vicinity, GPS turn-by-turn directions and potential individual parking spaces. Users can indicate to the system the location of vacant individual parking spaces, which information is broadcast to other users in the vicinity. Information about metered parking and parking lots can also be uploaded to the system and displayed.

### FIELD OF THE INVENTION

The present invention relates to vehicle navigation and direction systems and, more particularly, to vehicle direction systems that provide parking information.

### BACKGROUND OF THE INVENTION

With the advent of global positioning satellite systems (GPS), one of the uses of GPS has been in vehicle directional guidance systems or automotive navigation systems (ANS) that provide a vehicle driver with precise directions as to how to travel from one location to another predetermined location. Initially these ANS were purpose built into the controls of a vehicle. However, more recently they are in the form of third party add on software applications. These add-on applications may reside on a cellphone whose display is used to guide a driver or on a cellphone that is connected to the vehicle's display system, e.g., Apple CarPlay®.

The ANS systems, both purpose-built and third-party software are typically augmented with information other than mere directions. For example, they may show points of interest such as gas stations, stores and parking lots. Some of these third-party applications, such as Waze and Google Maps, provide the ability for the community of users to include additional information into the system which can be shared with other drivers. See U.S. Pat. No. 9,275,544 of Levine et al. This can include information about vehicles on the side of the road, police action, traffic cameras, etc.

Any vehicle trip is not concluded until the vehicle has arrived at the desired location and been parked. In rural and other sparsely populated areas, parking spaces are typically available, likely without cost. However, in more densely populated areas, e.g., large cities and even rural business areas that are not associated with large parking areas, finding a parking space can be challenging. A great deal of city and urban traffic is created by vehicles searching for parking spaces. This creates traffic congestion and lost time and further adds to air pollution.

According to the INRIX 2023 Global Traffic Report, motorists in all of the United States search for parking spots on streets, in lots or garages for an average of 17 hours a year. Americans pay more than $20 billion per year for parking, amounting to $97 per driver. New York, Chicago, Los Angeles, Boston, and Miami are the top cities in which parking quests endure the highest hours of wasted time, with 101, 96, 89, 88, and 70 hours per person each year. The indirect out-of-pocket expenses of searching for parking are much higher than this, with parking quests costing an estimated $345 per US citizen in wasted time, fuel, and emissions per driver. Certain cities are devastated by these indirect costs, such as New York City where parking searches amount to an estimated yearly $2,243 per driver in wasted time, fuel and emissions; and approximately $4.3 billion dollars in costs to the city. In addition, people typically overpay for metered parking, due to the difficulties in predicting how long they may need the space and fear of a parking ticket if the time runs out. Also, the difficulty of predicting how long it will take to find a free parking space causes them to surrender to a parking garage for fear of being late to an appointment. This can be very costly, as parking in Manhattan is estimated at $69 per day. Thirty percent of traffic in inner cities is caused by people looking for parking, contributing to 1.3 kg of CO₂ emissions per parking search; with congestion increasing each year. An astronomical number of cars enter cities each day. For example, there are more than 900,000 vehicles entering Manhattan each day, with traffic moving an average of 7 miles per hour; forcing cities to implement measures such as congestion pricing.

Transportation is one of the biggest contributors to a person's individual carbon footprint. Using a projection for the City of New York in Manhattan the 1.3 kg of CO₂ emissions per parking search×900,000 cars equals a carbon footprint of 1,170,000 kg (1289.7 tons) of CO₂ emission per day. This translates into a level of emission that significantly contributes to air pollution (including smog, carbon monoxide, and other toxins) and supercharges the natural greenhouse effect, with its devastating impact on global warming and the health of the planet and its inhabitants. It is estimated that the global CO₂ footprint needs to see a decrease of 2 tons per year by 2050 to avert a critical 1.5-degree Celsius rise in temperature (Intergovernmental Panel on Climate Change, 2023). This would be possible by effectively directing traffic through novel technological solutions.

As part of indirect costs, congestion poses a threat to local shops and businesses. An overwhelming 60% of drivers avoid driving to these destinations due to parking costs and hassles. The mental toll of parking compounds the problem, with nearly two thirds of drivers in the US reporting finding parking a stressful experience, 42% having missed an appointment because of parking, 34% abandoning their trip and 23% experiencing road rage due to parking. Trying to find parking can contribute to distractions while driving, increasing the risk of accidents and issues of safety. The signage for parking is often very small and confusing. This further slows down the process while drivers try to read the small print on the signs. This slow-moving parking search can also be dangerous, e.g. for pedestrians and cyclists due to driver's attention of parking and not objects in their way. (INRIX, 2023).

As noted above, some ANS applications provide the locations of parking lots, which eases the burden. However, as noted above, parking in lots can be expensive. For example, in New York City costs for parking in lots vary depending on location. Lots closer to attractions (e.g. Times Square) cost more than those farther away, which will still be fairly expensive. Also, when a lot is found it may be full, so the search continues. There is no cheap parking in NYC and other major cities on the North American continent, other than parking for free on the street—and that's a never-ending competition among countless drivers looking for open spots that aren't restricted by fire hydrants, bus stops or driveways. Not only may some parking lots or garages be full, but some garages may not even be open to public parking, as they may be entirely committed to residents or office workers who have monthly or annual parking permits. Some have limited hours, e.g., they are not open overnight.

As a partial solution to the full parking lot found using an ANS application, a system has been proposed that acquires parking lot information about the spaces available in a parking lot. See JP 7114912B of Aisin Corp.

As an alternative to a parking lot, there is metered parking on streets. Previously, this consisted only of spaces with physical coin-operated parking meters at each parking space. This evolved into an area parking station at which parking for a number of spaces can be paid by cash or credit card. Currently, there are remote systems, such as ParkMobile, that can accept payment for parking spaces over an entire parking facility of many streets of an urban area controlled by a municipal parking authority. While these systems can inform the municipal parking authority whether parking has been paid for at any particular parking spot, they cannot tell whether a car is actually parked at the spot and that information is not shared with drivers looking for spots.

The most prized accomplishment in parking is to find a free parking space on the street. Drivers slowly circle areas for a long time, e.g., up to an hour, trying to find one of these spots or waiting for one to become available. However, the period of time when parking is available at any one spot varies, and typically there is at least some time when no parking is permitted at the spot to allow for street cleaning (called alternate side of the street parking). The available street parking is regulated and is indicated by signs posted on the streets. Part of the slow-moving traffic is due to the fact that drivers need to read the parking signs to determine whether parking is legal at a particular section of street at that time. A community-based parking application called Spot Angels can be used to find free parking. https://www.youtube.com/watch?v=RnXs87bVbs0. It displays a map of streets with indications of parking lots as well as where free parking on the street is located and how long a vehicle can be parked there. It also tells the user how many other users of the program are parked there. Further it displays the cost of parking where there is metered parking. Users post information to the system about available parking spaces. The street map for Spot Angels is based on Open Street Map (OSM), which is an open source and fully editable base map, augmented by street parking sign information. This application is available in major cities in the U.S. and Canada.

While Spot Angel determines whether a vehicle is in a parking location by reports from the community of users, there is no guarantee this information is accurate, or the situation has not changed. U.S. Pat. No. 10,964,209 discloses a parking management system in which digital cameras are focused on the parking spaces to determine if they are filled. This of course is extremely expensive to implement and maintain. Further, free parking spaces on the street are not precisely defined. Some cars are parked close to others, and some are parked at greater distances. Also, fire hydrants, bus stops and driveways use up some of the available space. Therefore, even with camera outputs, the exact number and location of parking spaces cannot be accurately determined, so their availability is also uncertain.

### SUMMARY OF THE INVENTION

The present invention is directed to computerized methods and systems that operate to improve the management of vehicle parking.

The invention, referred to herein as Z-Park, is a community-driven parking application that offers turn-by-turn direction and navigation information about available parking spaces or spots to users of vehicle guidance systems or smartphones and tablets equipped with GPS navigation applications. Z-Park combines currently developed systems for mapping and guidance with various methods for determining the availability of parking spaces, e.g., on-street parking signage repertories coupled with Artificial Intelligence (AI) to define individual parking spaces along a street that permits free parking at certain times as well as user community input when a space is occupied. Z-park guides users to the closest available public spot to their intended destination. The AI can be trained on surveys of parking spaces in various areas. Also, it is retrained by data from the user community on the number of cars parked along a particular street.

The parking spots are generated and displayed in real time on a map. In the first instance, the user community can identify vacant parking spaces on the street. This can be an indication in general or based on estimates of the size of this space compared to the size of the user's car registered in the mobile application. Further, municipal parking databases can identify metered on-street parking spots on the basis of whether the time on the meter has expired or is about to expire. In addition, available spaces in parking lots can also be identified on the display.

While not currently available commercially available, real-time satellite imaging systems can be deployed to determine whether parking spaces are occupied. In particular, a series of real-time satellite imaging systems can be deployed which focus exclusively on parking locations on streets where parking is permitted without imaging the neighboring buildings.

The images from such a satellite system would be able to identify the spaces along streets where parking is permitted and whether those spaces are occupied in near real time. This cannot only indicate available on-street parking, but it can provide input to the AI system as to actual conditions as a way of improving or retraining its parking space predictions.

Z-Park has added features such as, when metered parking is used forecasting estimates of parking time, enabling users to more precisely estimate time of departure. Once parked the application can provide directions to the destination from the parking spot and real-time advertisements based on the user's location. As a safety feature the system can provide instant texts to selected contacts to let them know that the user has arrived safely, location and directions back to the parked car. In addition to the location of parking spots, the community can input information about objects they come across while finding parking (e.g., traffic jams, police action, roadblocks, accidents, or even construction).

### BRIEF DESCRIPTION OF THE DRAWINGS

The foregoing and other objects and advantages of the present invention will become more apparent when considered in connection with the following detailed description and appended drawings in which like designations denote like elements in the various views, and wherein:

FIG. 1 block diagram of a computerized community-driven parking system according to the present invention that operates to provide a user with turn-by-turn direction and navigation information about available parking spaces as illustration in the display of FIG. 1;

FIG. 2 is a schematic illustration of a display on a personal navigation device, such as a mobile phone, equipped with the navigation application of the present invention showing the availability of parking spaces on the streets for several city blocks in the vicinity of the device;

FIG. 3 is a flow chart of the general operation of the system of the present invention;

FIG. 4 is real-time satellite imaging system surveying the parking spaces in several city blocks; and

FIG. 5A is an illustration of a vehicle using the system and signalling the system when it has occupied a parking space and FIG. 5B shows additional features of the system where, where once the user has exited the parked vehicle, a display is provided on the application showing available services in the area.

### DETAILED DESCRIPTION OF THE INVENTION

The Z-Park community-driven parking application can be downloaded to iOS and Android mobile devices, such as smart phones, IPads or tablets, which are either standalone and connected to the display system of a vehicle or are part of a vehicle internal GPS navigation system. The Z-Park system can also be directly incorporated into vehicle internal GPS navigation systems. The Z-Park can be self-contained or built as an accessory to currently developed community-driven ANS applications that provide directional guidance, such as Waze. See for example U.S. Pat. No. 9,275,544 of Levine et al. (assignors to Waze Mobile Ltd), which is incorporated herein by reference in its entirety. As a result, like Waze, Z-Park can provide users of smartphones and tablets as wells as vehicle internal GPS systems with turn-by-turn directions and navigation from an origin location to the general vicinity of a destination. However, Z-Park additionally provides directions to available parking spaces or spots near the destination.

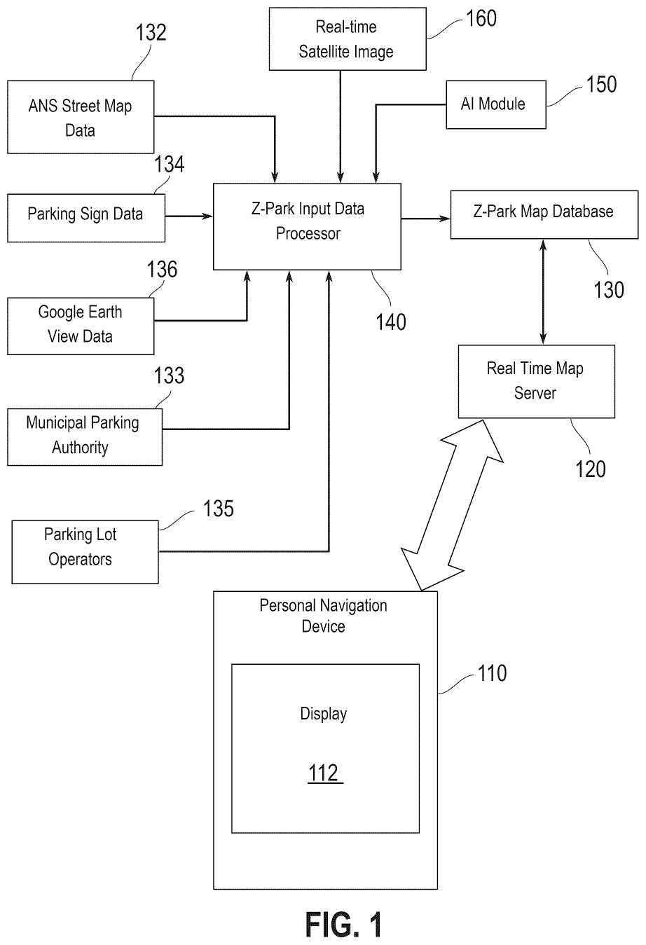

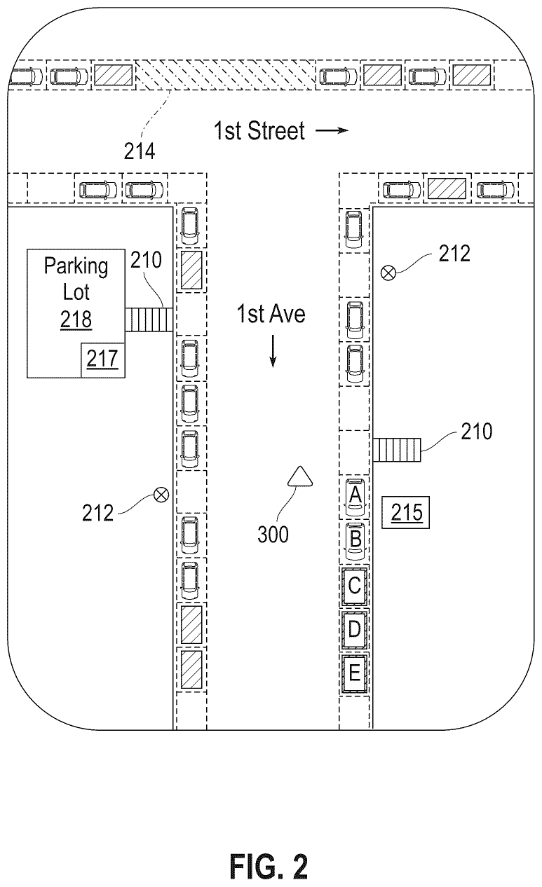

In order to effectively operate, Z-park needs a database of parking spaces. It is common with current ANS applications to have a map database of streets delivered to users by a real time server (RTS) or Map Server 120, as indicated in the identified Waze patent and as shown in FIG. 1 of this application. An ANS personal navigation device 110, e.g., a smart phone loaded with the program, has a display 112 which shows the streets in the vicinity of the vehicle, perhaps augmented with points of interest, e.g., parking lots, grocery stores and gas stations. See FIG. 2. The information on streets is delivered by the server 120 to the device 110.

This map database 130 provides the information to the server 120. The map database is loaded data from an input data processor 140. Processor 140 receives typical ANS street map data 132, which it can store in the database 130. Further, processor 140 receives street sign information 134 from various governments, e.g., cities, about the parking rules on specific streets at specific times. It processes this information into real-time parking areas. This is like the Spot Angels software previously referenced. The processors 120 and 140 may be two or more separate computers or software modules in a single computer.

This information on street signs is available from databases of on-street parking signage. Many municipalities provide this information. For example, data that geolocates traffic signs regulating on-street parking are available from the government and City of Quebec as well as cities in the US taking advantage of the Open Mobility Foundation. www.openmobilityfoundation.org/. This includes data such as that provided by the Parking Regulation Locations and Signs database for New York City, the Parking Zone information database on the Chicago Data Portal and the “Code the Curb” information for the City of Los Angles.

While these databases indicate streets where parking is permitted, and they need to be coordinated with a map of the street, as is done in the SpotAngel application. However, that system cannot identify a particular parking spot, e.g., the linear feet that will accommodate the typical vehicle, which is 14.7 feet in length. However, the length of cars depends on the model type, e.g. a compart care may be less than 14 feet long, while a midsize car is between 14 and 16 fee, while a full-size car may be 16 to 18 feet. Giving about 1 and ½ feet in front and behind, a parking spot that would accommodate most cars would take up about 21 linear feet of the street. Further, drivers do not aways part in a neat row and may end up using more or less space than necessary. Driveways and fire hydrants also use of some of the available parting space. The types of vehicles parking in any particular area may be more of one type than another. In order to maximize the parking spots designated for any section of street the present invention utilizes the AI module 250 to predict the space that should be available for parking.

However, the sign data merely states that parking is permitted along a certain side of the street during a certain period. It does not identify specific parking spaces along that street. To help compensate for this the processor 140 also receives street level map data 136 from Google Earth. https://www.google.com/earth/about/. Google took video of most streets in the US and Canada, as well as other parts of the world and geo-synced it. Thus, in Google Maps a location can be indicated and an image of the street can be viewed at that location. In this mode travel along the street can be imaged and parked cars or parking spaces viewed. The images from Google Street view, however, may be many months old, so they cannot identify current parking spaces. However, the images are still useful in identifying potential parking spaces (where cars are or could be parked) and relatively fixed structure at which parking is not permitted, e.g., driveways or fire hydrants. This information is compiled in the Z-park database.

While the identification of street parking spaces from Google Street view may be done manually, according to the present invention an AI module 150 is used by the processor 140. It may be trained to view the images for a street where parking is possible, at least at some times, and to log the potential parking spaces, driveways and fire hydrants and other features that effect whether a vehicle can be parked as a particular location. This can be done sequentially by the Z-park system for all streets in its database that have been identified as potential parking spaces by the government parking sign information.

In addition, operators of the Z-park system may choose to supplement or corroborate the Google Street information, whether manually or AI generated, by surveys. In these surveys, vehicles equipped with cameras may be sent to traverse the same streets. This camera information is compared with the Google Street information to determine any discrepancies, with the Z-park survey information taking precedence. As an alternative or in addition, the Z-park operators can commission users to provide updated survey data as they circle their neighbourhoods looking for free parking spaces. They may be commissioned by providing incentives to the users, e.g., a discount on fees or free parking space priority information. Whenever the system detects a newly opened space, as described below, notification is sent to users in the area. A survey commissioned user may be incentivized by an earlier notice, e.g., 15 seconds.

With the Z-park database as configured up to this point, which has fulsome information on possible parking spaces, what is further required is information on the real-time availability of a parking spot. The most straightforward way of providing real-time parking availability is through incentives to the user community. The system information is downloaded to a mobile device and is displayed there. As the user drives around looking for a parking space the system display may look like FIG. 2, which is a view of the street and potential parking spots. If the user parks in one of the spots, he is incentivized to indicate this by pressing twice on the space on the display 112. This real-time information about whether a car is parked in a designated parking space is sent from the personal navigation device 110 back to the real time map server 120, which in turn stores it in the map database 130 and then transmits it to the personal navigation devices in other vehicles in the vicinity. This transmission if parking space occupancy information, for example, can earn the user a system point that can be used as described more fully below. If, however, the user sees an additional space, he is encouraged to press the display at the location of that space on the map. This, for example, may earn the user two points, if verified.

The Z-park system notes the indication of a free space from a user and broadcasts it to other users in the vicinity. If another user takes the spot, the reward to the first user is verified and he earns the two points. The user taking the second spot can earn a point by indicating to the system that he has taken the spot.

In addition to information from the user community about available free on-street parking spots, the Z-park system can also rely on information from municipal parking authorities 133, which have designated metered parking spots and can provide information on whether time has run out or is about to run out at a specific parking spot. This information on metered street parking data can be obtained from systems such as ParkMobile, https://parkmobile.io/ and Passport Parking, https://www.passportparking.com/. These applications are pre-programmed with data on parking spots designated by local government. A user can pay for metered parking through these applications, but they don't provide a user with directions to any particular parking spot and don't identify which locations are free. By integrating this information into Z-Park, this defect can be overcome.

The Z-park system can contract with these systems to obtain this information about assumed free or about to be free spots. This data is processed by processor 240 and is added to the database 130. As is known, sometimes cars leave these metered parking spaces before the allotted time and sometimes they stay over the time. This information can be passed on to users in the vicinity of expired or about-to-expire parking spaces. However, in one embodiment, the AI module 230 is used to predict the likelihood of one of these spots being available. The inputs to the AI module include the time left on the metered parking space and the time when is refilled, as well as whether it was refilled by a Z-park user.

Still further the Z-park operators can contract with systems 135 that provide information as to whether a parking lot is full. As mentioned above, a system that acquires parking lot information about the spaces available in the parking lot is described in JP 7114912B of Aisin Corp, which is incorporated herein by reference in its entirety. Further, the Z-park operators can contract with individual parking lots so as to allow them to upload to the system a notice that the lot is full. It will be attractive to these lot owners because when they are not full, their lot can be indicated on the display with a flag (e.g., of a particular color) indicating they have space, which may attract Z-Park users to their lot. The alternative for a Z-Park user is to try other lots in the hopes that they are not full.

As shown in FIG. 2, the personal navigation device can display the streets in the vicinity of the user vehicle 300, which is displayed traveling on First Avenue toward its intersection with First Street. In the display, for example, the parking area on the sides of the streets can be indicated with dashed lines. The separation of the area into parking spaces or spots is shown by dotted lines. This specific identification of parking spots is unique to the Z-park system. As can be seen from FIG. 2, part of the street area where parking is legal, is none the less unavailable because of driveways 210 and fire hydrants 212. Also, some of the area may be prohibited, e.g., area 214 under traffic light 216 at the street intersection. Free legal on-street parking can be shown in the display as cross-hatched areas. Metered street marking, e.g., spots A, B, C, D and E area. The station 215 for paying for parking at these spots is also shown. In addition, a parking lot 218 is shown on First Avenue. It has a flag 217 which will be one color on the display if it has spaces and another color if it is full.

As is common with some community-based navigation systems, the Z-Park user community can indicate to the system the location of certain traffic conditions, accidents, police, abandoned cars, etc. In order to be useful for metered and free street parking, additional information is needed. In particular, the locations of metered and free parking spaces need to be known and displayed on the street map.

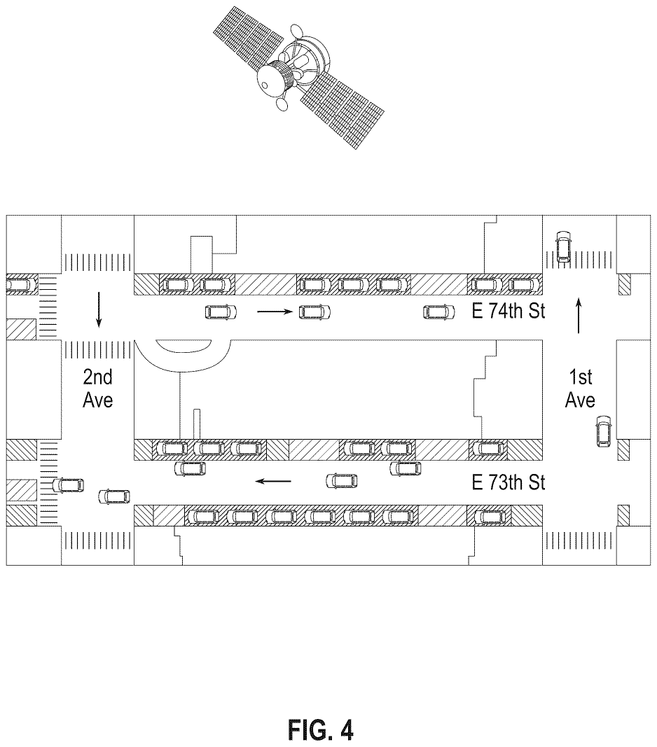

While not currently available commercially, real-time satellite imaging systems can be deployed to determine whether parking spaces are occupied. See FIG. 4 In particular, a series of real-time satellite imaging systems can be deployed which focus exclusively on parking locations on streets where parking is permitted without imaging the neighboring buildings.

The images from such a satellite system 160 (FIG. 1) would be able to identify the spaces along streets where parking is permitted and whether those spaces are occupied in near real time. This information would be input to the data processor 140, which in turn would store it in the map database 230. This cannot only indicate available on-street parking, but it can provide input to the AI system as to actual conditions as a way of improving or retraining its parking space predictions. In particular, the AI can be trained on the basis of detected parking spaces and can estimate the correspondence of the space to the size of the user's car registered in the mobile application

As another option, Z-Park allows the system user to get to the available parking spot using voice guided navigation.

Using the sign data from a city, the system indicates on the map those locations where there are metered parking and free parking on the street by different color bands. These colors indicate possible free street parking and metered street parking locations. They change based on any time limits set by the parking data. Using metered parking data from a city, a portion of the band where a parking fee was paid and remains unexpired, changes to narrow crosshatching, i.e., occupied. The indication remains for a portion of the remaining time, and then changes back to wide crosshatching on the assumption that some people depart before expiration of the time or soon after. It changes to another indication (dotted) when it becomes available (expiration of the time).

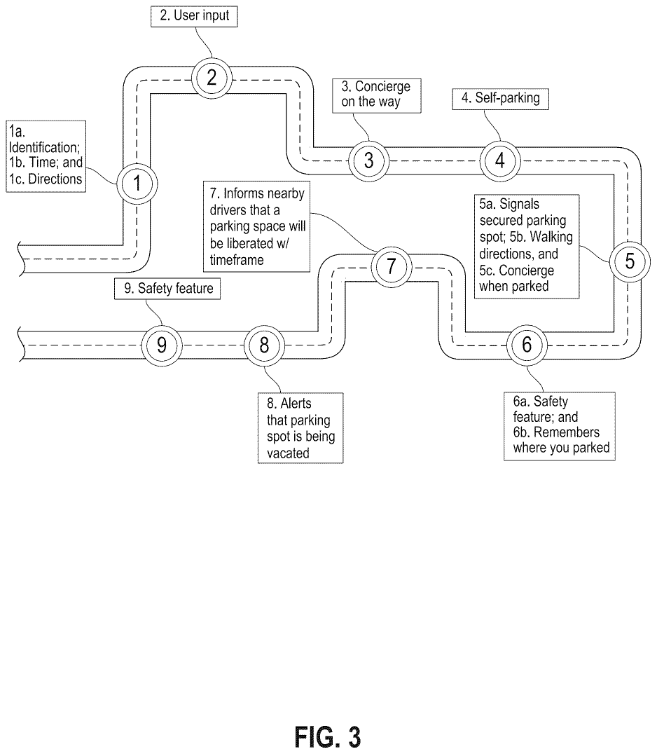

FIG. 3 is a flow chart of the operation of the Z-Park system. It begins with step 1 IDENTIFICATION where the application provides an estimate of the time to park based on both traffic and the parking situation, enabling users to more precisely estimate the appropriate time of departure. The application forecasts the parking situation based on information in the Z-park Map database of the current parking situation at the designation as achieved by the various means discussed above. Further, at this stage, the parking situation information can be implemented with AI based on data from previous years to better estimate the time to arrival based on month, day, and time of day. As part of step 1 the application identifies public parking spots around the final inputted destination on a map shown on the display 112 based on information from database 230 as developed by the system.

At step 2 USER INPUT the users exchange and update information about the objects they come across while finding parking. Whatever the situation—traffic jams, police action, roadblocks, accidents, or even construction—Z-Park uses the data to run algorithms that determine the optimum route and even adjust the route-planning in real-time based on user-submitted updates. Importantly, the users also input information about available on-street free parking spaces. This information is received by real time map server 120, processed and broadcast to users in the vicinity.

At step 3 CONCIERGE ON THE WAY, audio and visual adds may be broadcast from server 120 and displayed on device 110 showing services along the way. These real-time advertisements can be displayed based on the user's location. In connection with this Z-Park may employ a pay-per-click pricing model for its services and uses in-application location-based advertising. Advertisers can select from the following Z-Park-specified ad formats:
Branded Pins that appear on Z-Park maps while the user is driving; they resemble store signs.
Search advertisements that appear above search results when a user conducts an internal application search.
Zero-Speed Takeover in the form of electronic billboards that appear when a car stops for a minimum of three seconds.

In addition to displaying these advertisements on the user interface, Z-Park refreshes them in real-time based on the user's position to show advertisements for the stores that are nearest to the user. Companies may join up for a certain amount based on how many locations they represent. For example, they can join for as little as $5 per day, for brands with fewer than ten locations, and as much as $100 per day for organizations with more than ten locations.

At step 4 SELF-PARKING: Z-Park could eventually be integrated to self-parking cars systems, which would take over once the car has reached their parking space. In particular, Z-Park could be integrated into self-parking car systems, which would take over driving the car once the car has reached the selected parking space and would guide the car in parking at a selected free on-street parking spot.

According to step 5 SIGNALS SECURED PARKING SPOT, once the vehicle is parked, the Z-Park mobile application registers with the system that the user has parked in the space, and that the parking space is now unavailable.

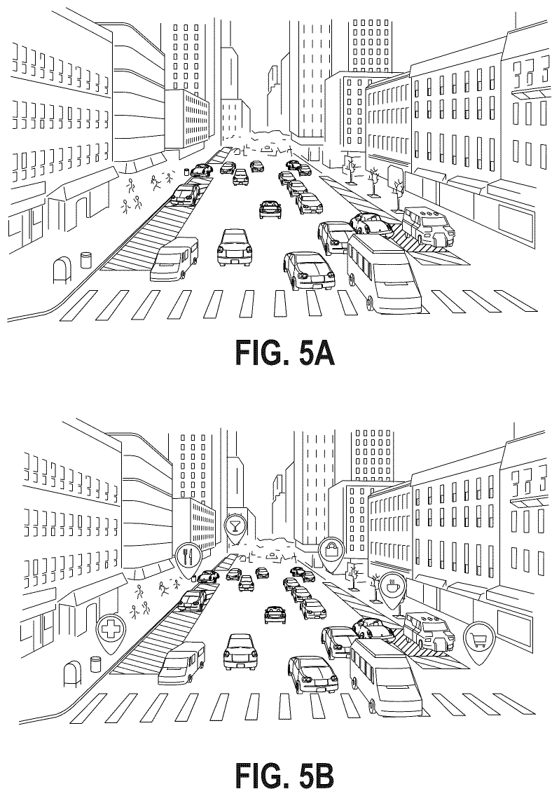

Once parked, the mobile application can provide walking directions to the destination including data on walking distance and approx. number of minutes to get there. Also, with concierge service, once parked, the application provides the user with information about nearby available services (e.g., wine and liquor, flowers, pastries, shoeshine, etc.), which can be useful to a Z-Park user if he or she needs to pick something along the way while walking to the destination. FIG. 5A is an illustration of a vehicle using the system and signalling the system when it has occupied a parking space. The crosshatched spaces indicate potential metered parking locations. FIG. 5B shows additional features of the system where, where once the user has exited the parked vehicle, a display is provided on the application showing available services in the area such as groceries, dining, medical, etc.

This is particularly helpful because the desired service may be nearby, but out of sight, e.g., around the corner.

As an optional safety feature, at step 6, the system allows the user to or automatically sends instant texts messages to selected contact people to let them know that the user has arrived safely at the destination. Further, the system stores the location of the parking spot for easy reference so the user can find the car once ready to return home or to another destination.

According to step 7, INFORMS NEARBY DRIVERS, as soon as the driver leaves the destination, e.g., begins walking after having stopped at the destination, the Z-Park application sends a query to the user asking whether they are planning to go directly to their car and whether they intend on exiting the parking space. If so, the application broadcasts this information to other users in the vicinity that a parking space will be free within an approximate timeframe calculated based on the walking time to the vehicle. As an option, the user can provide a time when he/she expects to leave the parking space, e.g., if the user is going to make an additional stop while walking back to the car. Once the user is back in the car, the application encourages the user to indicate when they are leaving the space so other users can use occupy it.

At step 8 ALERTS THAT PARKING SPOT IS BEING VACATED, once the user is back in the vehicle, the application encourages the user to indicate when the space is/will become vacated so other users can find/occupy it. This implies that every time a user uses the app, Z-Park's users are basically adding value to the program itself, enabling Z-Park to provide free traffic and navigation services in addition to gathering important data for future service improvements.

As soon as the driver moves the car from the parking space, the system indicates that the application identifies the parking spot as free to other users close by.

As a second safety feature at step 9 SAFETY FEATURE, the system facilitates the user in sending or automatically sends an instant text to selected contact people when the user returns to the place of origin to let them know that that user has arrived safely home.

Z-Park directions are basically visual and are shown on the map display. However, in addition the system can provide audio messages, voice guided navigation, that provide the user with guidance to the available parking spots.

Z-Park finds best available parking in real time, but the identified parking cannot be reserved so its availability can change as parking spaces can be occupied, in which case the application will identify the next available parking space closest to its destination until a parking space is secured.

With Z-Park if a user is unable to park in the identified parking space, the user is prompted to notify the system, with information about why parking was not possible (e.g., another car is parked in the spot, the space is too small, etc.). The Z-Park mobile application will then identify the next available parking space closest to its destination until the user secures a parking space.

The present invention is a smart solution to an important urban problem, resulting in less wasted time, fuel and emissions, and a better quality of life for the city and its citizens.

The above are only specific implementations of the invention and are not intended to limit the scope of protection of the invention. Any modifications or substitutes apparent to those skilled in the art shall fall within the scope of protection of the invention. Therefore, the protected scope of the invention shall be subject to the scope of protection of the claims.

While the invention is explained in relation to certain embodiments, it is to be understood that various modifications thereof will become apparent to those skilled in the art upon reading the specification. Therefore, it is to be understood that the invention disclosed herein is intended to cover such modifications as falling within the scope of the appended claims.

1. A community-driven computerized vehicle navigation system that operates to direct vehicles to available parking spaces, comprising:
a parking map database;
a real time map server that transmits turn-by turn directions to a personal navigation device that includes GPS guidance system, a transceiver and a display, the personal navigation device being located in a vehicle to guide the vehicle to an available parking space based on data in the parking map data base;
a parking data input processor that receives information from which it generates data about potentially available parking spaces and stores it in the parking map database;
automotive navigation system (ANS) data source for providing information for guiding a vehicle from one location to a destination location in the form of GPS turn-by-turn directions on a map; the ANS source providing its map information to the parking data input processor from which it is sent to the parking map database;
an available parking space data source for providing information about potentially available parking spaces permitted on-street parking including time, date and street location, said available parking space data source providing its information to the parking data input processor where it is coordinated with the ANS information to form data for the parking map database which locates potential individual parking spaces on the GPS map data; and
wherein said real-time map server transmits information about available parking spaces to the display on the personal navigation device so as to assign guidance of a user to an available parking space. parking data input processor compares the earth/street view data with the parking spaces to confirm their accuracy and to store confirmed information in the parking map database for transmission to and display on the personal navigation device, and to assign guidance of a user to an available parking space.

2. The navigation system according to claim 1 wherein a user of the system can indicate one or more vacant individual parking spaces by pressing a location or locations on the display of the personal navigation device, which information is received by the real-time map server and stored in the map database.

3. The navigation system according to claim 1 wherein said available parking space data source is a parking sign data source providing information about on-street parking areas including time, date and street location and
further including a source of earth/street view data for providing images of a street from some point in the past, which is correlated with GPS map data, and
wherein said parking data input processor compares the earth/street view data with the parking areas to confirm the accuracy of available parking spaces in the parking area and to store confirmed information in the parking map database.

4. The navigation system according to claim 3 wherein free parking is allowed at the vacant parking space.

5. The navigation system according to claim 1 wherein a user of the system can indicate leaving an individual parking space that was occupied by pressing a location on the display of the personal navigation device, which information is received by the real-time map server and stored in the map database.

6. The navigation system according to claim 3 wherein the parking data input processor is coupled with or includes an artificial intelligence module, which separates potential parking areas into the individual parking spaces by predicting vehicle parking.

7. The navigation system according to claim 3 wherein the parking data input processor uses the earth/street view data to refine the parking space data to remove spaces containing fire hydrants, bus stops and driveways from the available spaces.

8. The navigation system according to claim 1 wherein the personal navigation device is one of a vehicle guidance system built into a vehicle, a smartphone, IPad and a tablet.

9. The navigation system according to claim 1 wherein said available parking space data source is a municipal parking space source for providing information as to whether a timed fee for a designated parking space has expired or is about to expire, the municipal parking space information is provided to the parking data input processor where it is coordinated with the ANS information to form data for the parking map database which locates individual metered parking spaces on the GPS map data, and stores it in the parking map database.

10. The navigation system according to claim 9 wherein the parking data input processor is coupled with or includes an artificial intelligence module, and wherein the artificial intelligence module is trained on the time left on the metered parking space and the time when is the charge for the space is refilled, as well as whether it was refilled by a Z-park user, in order to enhance the system's prediction of the likelihood of one of the parking spaces being available at a particular time.

11. The navigation system according to claim 1 wherein said available parking space data source is a parking lot status source for providing information as to whether related parking lots are full or have space for cars, the parking lot status information is provided to the parking data input processor where it is coordinated with the ANS information to form data for the parking map database which locates parking lots that are not full on the GPS map data, and stores the parking lot status in the parking map database.

12. The navigation system according to claim 1 wherein said available parking space data source is a source of real-time satellite images of parking spaces in the vicinity of the vehicle to determine whether the spaces are vacant or not, the real-time satellite image information is provided to the parking data input processor where it is coordinated with the ANS information to form data for the parking map database which indicates whether individual parking spaces are vacant on the GPS map data, and stores the vacant individual parking space information in the parking map database.

13. The navigation system according to claim 12 further wherein the parking data input processor is coupled with or includes an artificial intelligence module, and wherein the artificial intelligence module is trained on the real-time satellite image information to improve its prediction of parking spaces.

14. The navigation system according to claim 1 wherein parking map database further includes advertisements geolocated with the user's location which are sent to the real time map server and transmitted to the personal navigation device and shown on its display during the time the system operates to direct vehicles to available parking spaces.

15. The navigation system according to claim 1 wherein the real time map server automatically sends arrival and/or departure messages to selected contacts when the user parks the vehicle or leaves a parking space.

16. The navigation system according to claim 2 wherein the user is rewarded for indicating vacant individual parking spaces.

17. The navigation system according to claim 5 wherein the user is rewarded for indicating when leaving an individual parking space that was occupied.

18. The navigation system according to claim 16 where in the reward can be early or priority notice of a vacant free parking space in the user's vicinity.

19. The navigation system according to claim 17 where in the reward can be early or priority notice of a vacant free parking space in the user's vicinity.

20. The navigation system according to claim 1 wherein the system is installed in a self-driving car and wherein the information in the parking map database for display on the personal navigation device is downloaded to the personal navigation device, and the personal navigation device is connected to the driving controls of the self-driving car so as to drive the car and park it in an available parking space.

21. A method for providing vehicle navigation comprises the steps of:
obtaining information on potential parking spaces and storing the information, wherein the information is obtained from an automotive navigation system (ANS), parking sign data and earth/street view images;
processing the information with an input data processor with an AI module, to generate individual parking space data that is stored in parking map database;
sending the information from the map database to a real time map server,
the real time map server transmitting data from the database to a personal navigation device that is in the vehicle so as to show on a display of the personal navigation device the streets in the vicinity of the vehicle and potential individual parking spaces;
accepting input from the user community indicating any of the individual parking spaces that are vacant; and
sending information about available parking spaces to other users of the system in the vicinity.

22. The method of claim 21 wherein the real time map server further transmits GPS turn-by-turn directions to the personal navigation device.

23. The method of claim 21 further including obtaining information about metered parking and parking lots and causing it to become part of the display of available parking spaces.
